(19) United States
(12) Patent Application Publication
(10) Pub. No.: US 2021/0017956 A1
(43) Pub. Date: Jan. 21, 2021

(54) Wind tower complex

(71) Applicant: Sektong Chan, Chicago, IL (US)

(72) Inventor: Sektong Chan, Chicago, IL (US)

(21) Appl. No.: 16/501,666

(22) Filed: Jul. 17, 2019

(51) Int. Cl. F03D 3/00; F03D 9/34; F03D 80/70; H02K 7/18

(52) U.S. Cl. CPC F03D 3/005; H02K 7/183; F03D 80/70; F03D 9/34

(57) ABSTRACT

Today's energy and renewable energy production systems are inefficient! Expensive, Pollution, Low production and even spoiling the natural environment! I improved the existing equipment systems and invented an advanced renewable energy production system “Wind Tower Complex” are able to produce almost free unlimited renewable energy! All obtain from Earth Spinning energy. No fuel needed, zero emission! Our system is composed of 3 sections. First; dual alternator wind turbines. Second; Integrated circuit wind turbine Tower. Third; perfect arrangement of energy production. Able to use all the single drop of energy!

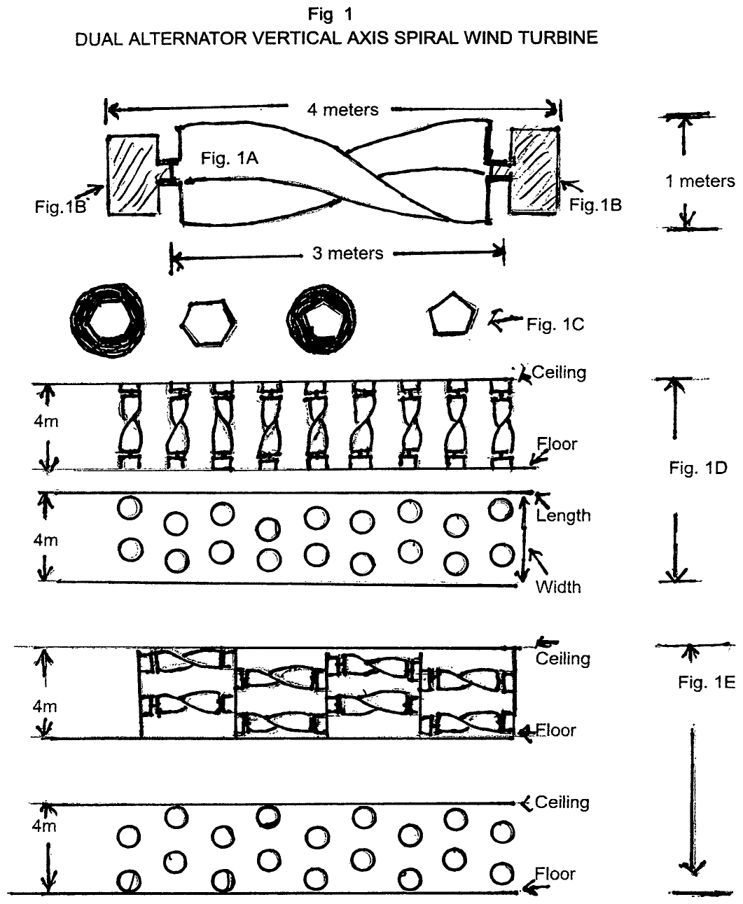

FIG. 1—Dual Alternator Spiral Vertical Axis Wind Turbine. This is an improvement of popular vertical spiral wind turbine most are on sale at Alibaba and Amazon under thousand dollars. And using for street lighting. But expensive and inefficient! Our wind turbine is simply divided into three parts.

FIG. 1A; Spiral wind turbine rotor 1×3 m both end with hex socket.

FIG. 1B; Two 20-30 Kwh Alternators with hex head.

FIG. 1C; Hexagon head and hexagon socket easy assemble method.

FIG. 1D; Vertical position array. All wind turbines are installed in standing vertical positions, with one meter apart with zigzag position. Attaching alternators on Ceiling and floor as diagram shown. Can catch wind from all directions.

FIG. 1E; Horizontal position array. Are all wind turbines are installed in horizontal position. All wind turbines are attaching on wall and panels as diagram shown. Only catch wind from one direction.

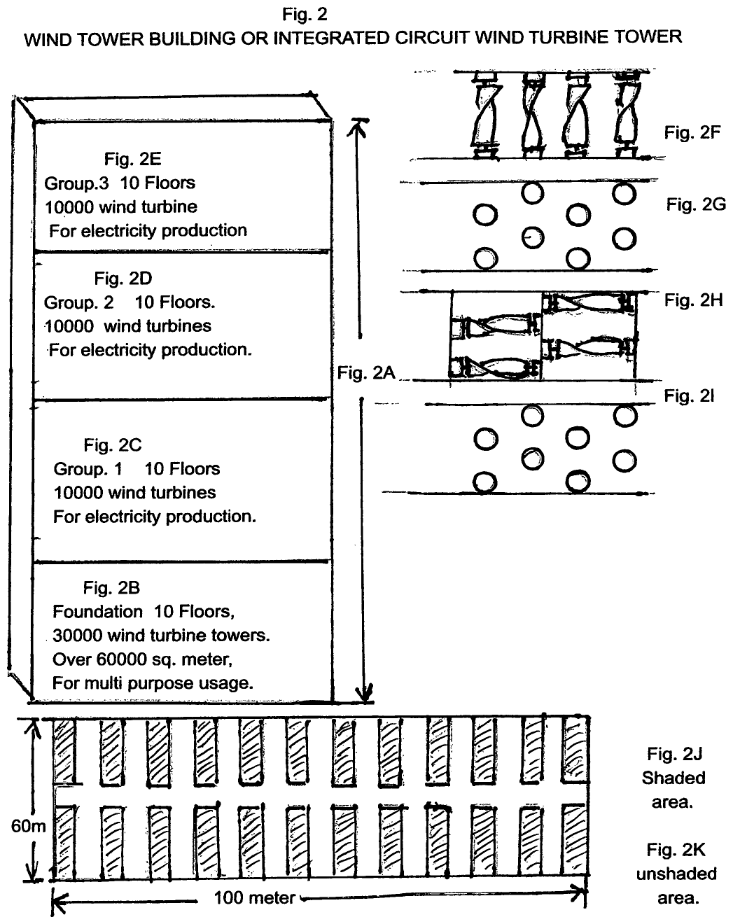

FIG. 2—WIND TOWER BUILDING; Money energy and space saving renewable energy production center (Tower Building). A building specially designed for instead individual wind turbine towers. And clustered array wind turbine save a lot of money for wiring, easy maintenance more stable durable and productive,

FIG. 2A; A forty storeys Wind Tower Building. Occupy 8000 sq. m. for renewable energy production and are divided into four sections.

FIG. 2A1; Section one; Ten storeys base foundation building. Instead of individual wind turbine towers. Boost the height of Wind Tower, to catch more wind. And created 60000 sq. m. area good for multi purpose facilities.

FIG. 2A2; Section two; Ten storeys each floor with internal space 100×60×4 meter to Install 1000 wind turbines, total 10000 wind turbines for electricity production.

FIG. 2A3; Section three. Another ten storeys building installed 10000 wind turbines for Electricity production.

FIG. 2A4; Section four; Another section for 10000 turbines for electricity production. Three sections 30000 dual alternators will produce over 1-2 Gwh. better than 2 Nuclear Power Plants or 2 Gansu Wind Farms! Only cost $200 million.

FIG. 2B; Vertical array wind turbines. Are all wind turbines attached on the ceiling and floor with one meter apart with zigzag position. As diagram shown. Can catch wind from all directions.

FIG. 2C; Horizontal position arraying wind turbines. Are all wind turbines arranged in Horizontal position attaching on wall or panels with one meter apart up down and zigzag position as diagram shown. Only catch wind from one direction.

FIG. 2D; Floor Plan of Wind Tower; Internal area of each floor, 100×60 meters by 4 meters height. Volume of wall ceiling and floor are not yet calculated. Total Internal space each floor is 100×60×4 m=24000 Cubic meters. Space good enough to install 1000×4 cubic meter wind turbines.

FIG. 2E; Area for Elevators, Stairs and Maintenance.

FIG. 2F; Shaded area to install 1000 wind turbines.

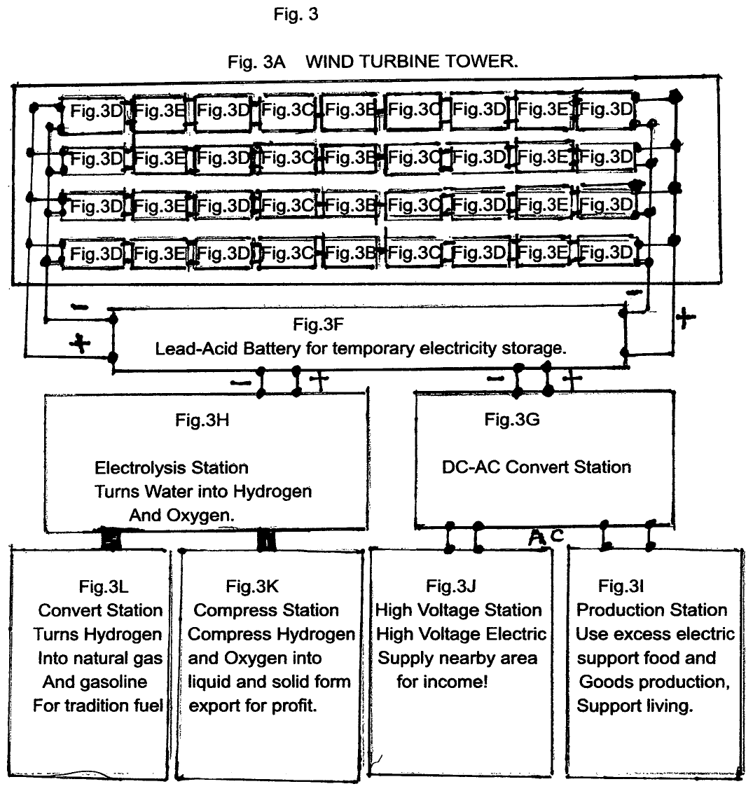

FIG. 3; WIND TOWER COMPLEX; A complex system to make use every single drop of electricity.

FIG. 3A; Wind Tower Building. A forty storeys building for renewable energy production.

FIG. 3B; Wind turbine rotor.

FIG. 3C; Alternators.

FIG. 3D; Switches, Common circuit breakers. Switches to protect the whole system.

FIG. 3E; AC to DC Converter. Alternating Current are no good for couplings. We use rectifier Diodes turn AC to DC for couplings.

FIG. 3F; Temporary electricity storage station. Lead Acid batteries for temporary storage of electricity.

FIG. 3G; DC to AC Converting Station. Turns DC to AC for today conventional electricity Usage.

FIG. 3H; Electrolyte Station; Electricity are difficult and expensive for storage and transmission. We are using electricity to convert water into Hydrogen and Oxygen for easy storage and transportation.

FIG. 3I; Production Sections. Because we can produce a tremendous amount of electricity. One unit will produce about 3 Nuclear Reactor's electricity. We may use these energies for Greenhouse to produce foods. Recycle Center for garbage. Metal refinery and all kinds of manufacturing for goods. Creating more jobs against poverty. And develop deserts for more lands more jobs more resources!

FIG. 3J; Transmission Station. Turns regular voltage to higher voltage supply nearby area

FIG. 3K; Storage and Transportation Station. Compress Hydrogen Oxygen into gas liquid even solid forms for easy storage and transportation export for income.

FIG. 3L; Energy conversion Station. Station turns Hydrogen to natural gas and gasoline by adding carbon (coal). For today's traditional fuels.

### SPECIFICATION

We are facing fatal climate disasters everyday! People invest and waste a lot of money on renewable energy to reduce emission to alter climate problems. Inefficiency renewable energy production system not only can't solve problem. But made problem worse. Even create more emission by production of inefficiency equipment and construction. And occupy large area to spoiling natural environment! Made climate problem worse. Earth spinning energy are perfect unlimited green sustainable energy. Only obtain one in billionth good enough supply all energy for the whole World. http://mb-soft.com/public2/earthrot.html During Earth rotation or spinning, create powerful wind or jet stream, perfect kinetic energy. We spent years invented better renewable production system “Wind Tower Complex” One unit only cost $200 million occupy 8000 sq. m. can produce 1-2 Gwh. better than Nuclear Power Plant or Gansu Wind Farm, cost over $10 billion. More unit will completely fix all energy, emission and climate problems on Earth! Our inventions are the improvement to maximum today exist equipment to get the best production. FIG. 1; DUAL ALTERNATOR SPIRAL VERTICAL WIND TURBINE; Wind turbine too big or small are inefficiency. And propeller wind turbine are occupy large area kills birds and bats. Most wind turbines are composed by so many parts, some heavy and complicated. Our dual alternator spiral vertical axis wind turbine are the improvement of today's popular vertical axis wind turbine most on sale at Alibaba and Amazon under $1000. And most of these wind turbines are working good for street lighting, but expensive and low production. Our dual alternator wind turbine only consists of 3 parts. With lighter weight and hex head and socket for easy installation. Only cost about $2000. But with 20-40 times of production! And two alternator four bearings attach on floor and ceiling inside building. Are more stable and durable. And greatly reduce frictions of swinging and gravitational force. FIG. 2; WIND TOWER BUILDING; Most wind farm are occupy large area. Spent a lot of money on building individual tower and wiring. And spoiling natural environment by constructions. Our Wind Tower Building is avoiding the above problems. FIG. 2A; Our Wind Tower Building is forty storeys building. With internal area 6000 sq. m. Occupy 8000 sq. m. FIG. 2A1; Section one. Ten storey building over 100 ft or 40 m. act as individual towers of all wind turbines. Boost the height of wind tower building catch more wind. And created 60000 sq. m. area for multi purpose facilities. FIG. 2A2; Section two, 10 storeys for electricity production. Each floor install 1000 turbines, 10 storey install 10000 turbines. Each turbine produce 40-60 Kwh will produce 400-600 Mwh. Compare and better than Nuclear Power Plant and Gansu Wind Farm. Easy maintenance, without fuel and zero emission production. FIG. 2A3 and FIG. 2A4 are the same, each produce 400-600 Mwh. three sections one unit will produce 1.2-1.8 GWh. only cost about $200 million better than 2 Nuclear Power Plants or 2 Gansu Wind Farm cost over $20 billion. More unit will completely fixed energy climate problems on Earth! Simple and easy. Assume 3 cents/Kwh one unit will have return of $105-157 million each year for over 40 years. Without fuel, zero emission! FIG. 2B and FIG. 2D; Cluster array of wind turbine, optimized to take advantage of each other's turbulence. More stable more productive! https://www.forbes.com/sites/jeffmcmahon/2016/04/29/stanford-small-wind-arrays-can-o utperform-conventional-wind-farms-with-no-bird-kill/#3ff822f7592a And cluster array of wind turbines act as forest can against fatal powerful storms. Better than individual turbine. FIG. 3; WIND TOWER COMPLEX. Today people invest and waste a lot of money to develop renewable energy. In order to fight against fatal climate change reduce emission. Inefficiency projects, not only can't improve climate problems. But even make problems worse! Create more emission by produce inefficiency equipment and construction. Occupy and spoiling large area by construction to increase global temp! For examples; Senate Bill 100; https://focus.senate.ca.gov/sb100/faqs It never succeed, but make the highest utility bill and create more forest wildfire on America! Paris Agreement; been 27 years, trillions of dollars wasted. Do nothing situation more worse! Our Wind Tower Complex Project are different. We are using cheap efficiency and recyclable equipment. Occupy small area can produce more than enough renewable energy for the whole World. Zero emission! And we are considering all situations. Make sure well use all electricity. FIG. 3A; Wind Tower Building, we can show we are using simplest shortest network to collect electricity. FIG. 3F; Temporary electricity storage section. Lead acid battery are the cheaper battery for temporary store electricity. Seawater battery are considered. FIG. 3G; Because we are collected direct current DC we must turn it into Alternate Current AC for conventional usage. FIG. 3H; electricity are difficult and expensive for storage and transportation. We are using electricity to convert water into Hydrogen and Oxygen into liquid and solid form easy for storage and transportation and export for profit. Platinum Anode electrolyte system, and HYDROGENIC company are considering! FIG. 3I; Production section; Because we produce unlimited energy. We can produce food, goods and create jobs with these energy. “This tiny country feeds the World” are very good example! https://www.nationalgeographic.com/magazine/2017/09/holland-agriculture-sustainable-farming/FIG. 3L; Energy conversion section; Hydrogen are possible turns into natural gas and gasoline, by adding Carbon (coal). For today's traditional fuel. Save money to change system. OUR WIND TOWER COMPLEX WILL COMPLETELY FIX CLIMATE AND ENERGY PROBLEMS. SAVE OUR PLANET! SAVE OURSELVES!

Today people realise energy is very important! If short or exhausted. Our world will collapse. Improper energy production systems, not only wasting money, but pollution and spoiling the natural environment. We are focused on these problems design and invented a better renewable energy production system “WIND TOWER COMPLEX”. Here are 3 invention and claims are listed on this chapter all are related. and all are the major components in “WIND TOWER COMPLEX”

1. Dual Alternator spiral vertical wind turbine. Only designed into three parts. Two alternators with hex head and one rotor with both end hex sockets. For easy assembly and installation. Two alternators did not add load on wind turbines. Two alternators four bearing made the turbine moving more smooth and quiet. All wind turbines are designed to put in building attached to the ceiling and floors. Make it more strong, durable and productive.

2. Wind Tower Building or integrated circuit Wind Farm. We follow Moore's Law. https://www.wikiwand.com/en/Moore%27s_law to design less space, less money install more wind turbines to produce more energy! Our design is a standard unit of forty storey building that install 30000 wind turbines. Only occupy 8000 sq. meters. Are able produce one Gwh. better than GW nuclear Power Plant. First 10 floors are base and foundation building, instead of building 30000 wind turbine's individual towers. Other thirty floors are divided into three separate sections for easy management. Each floor with 6000 sq. m internal space and install 1000 wind turbines. Each occupy 1 sq.m. 10 floors will install 10000 wind turbines. Thirty floors will install 30000 wind turbines. Each turbine with 2×20 KW. One tower will have 1200000 KW or 1.2 GW. More towers are good enough to supply energy for the whole world.

3. Wind Tower Complex. Most renewable energy production centers are not well considering their cost, production, situation and abilities of their centers. Some lost money, even bankruptcy! We are avoiding all the above problems. Because one of our units only occupies 8000 sq. meters. Can easily setup in or by cities, and high energy consumption areas. Save big money on the transmission network. And prevent big energy lost during transmission! And we are able to use excess electricity to produce food and goods! Copy the model “Tiny country feeds the World”. And electrolysis water into Hydrogen and Oxygen compress into gas, liquid even solid forms for easy storage and transportation! And able convert electricity into natural gas and gasoline for our conventional fuels. Save big money to change our traditional fuels systems. We can use this system to develop Deserts and Oceans. Create more land more resources. And alter the climate changes!
